(19) United States
(12) Patent Application Publication
(10) Pub. No.: US 2004/0020955 A1
(43) Pub. Date: Feb. 5, 2004

(54) Universal bar holder

(76) Inventor: Kenneth S. Darby, Exeter Township, PA (US)

Correspondence Address: Kenneth S. Darby, RR 1 Box 311, Falls, PA, 18615, US

(21) Appl. No.: 10/198,305

(22) Filed: Aug. 5, 2002

(51) Int. Cl. B60R 7/00; B60R 9/00; B60R 11/00

(52) U.S. Cl. 224/485; 224/488; 224/495; 224/506; 224/519

(57) ABSTRACT

The Universal Bar Holder is a square tube that slides over 2″×2″ square tube and has a means of holding a round or rectangular bar used to support kayak saddles when transporting kayaks above the roof of a vehicle.

### FIELD OF INVENTION:

This invention relates to a universal bar holder that slides over 2″×2″ square tubing or the “L” section of the patented Extend-A-Truck II, and can hold a round tube, or rectangular bar, both of which are standard to support kayak saddles.

### BACKGROUND OF THE INVENTION

Many items such as canoes, kayaks, and ladders are carried on top of a car or truck using a rooftop carrier in conjunction with the Extend-A-Truck II. This allows a longer distance between the supports, in comparison to utilizing only the rooftop carriers. The Extend-A-Truck II is a patented combination roof or bed height support that inserts into a standard insertion hitch. The support bar of the Extend-A-Truck II is a square tube that is too large to accept kayak saddles. These saddles fit a small, round tube (1⅛″ in diameter) or a rectangular bar (1¼″×⅞″). Adapters that convert the kayak saddles themselves to the larger support bar, are costly and a nuisance to the user.

### OBJECTS OF THE INVENTION

The object of the present invention is to provide a load support that can accept the base of kayak saddles, which requires either the round tube, or the rectangular bar for their mounting. This Universal Bar Holder will fit around a standard 2″ square tube with the capability of height adjustment and a means of holding a round tube or a rectangular bar that can support kayak saddles.

### SUMMARY

This apparatus enables a person to convert a large support bar on an Extend-A-Truck II, to a smaller, round, tubular, or rectangular support bar that will accept kayak saddles that support the kayak while in transit.

### BRIEF DESCRIPTION OF DRAWING

FIG. 1—Illustrates a view of the tube with multiple adjustment holes, two threaded studs, and a cap to hold the round or rectangular bar.

FIG. 2—Illustrates the Universal Bar Carrier in use with the round bar.

FIG. 3—Illustrates the Universal Bar Carrier in use with the rectangular bar.

### REFERENCE TO NUMERALS IN THE DRAWING

1. Tubular Frame

2. Adjustment Holes

3. Studs

4. End Cap

5. Hold-down Cap

6. Cut out shape for round tubing

7. Cut out shape for rectangular tubing

8. Hold-down nuts

9. Round Tube

10. Rectangular Tube

### DETATILED DESCRIPTION OF DRAWING:

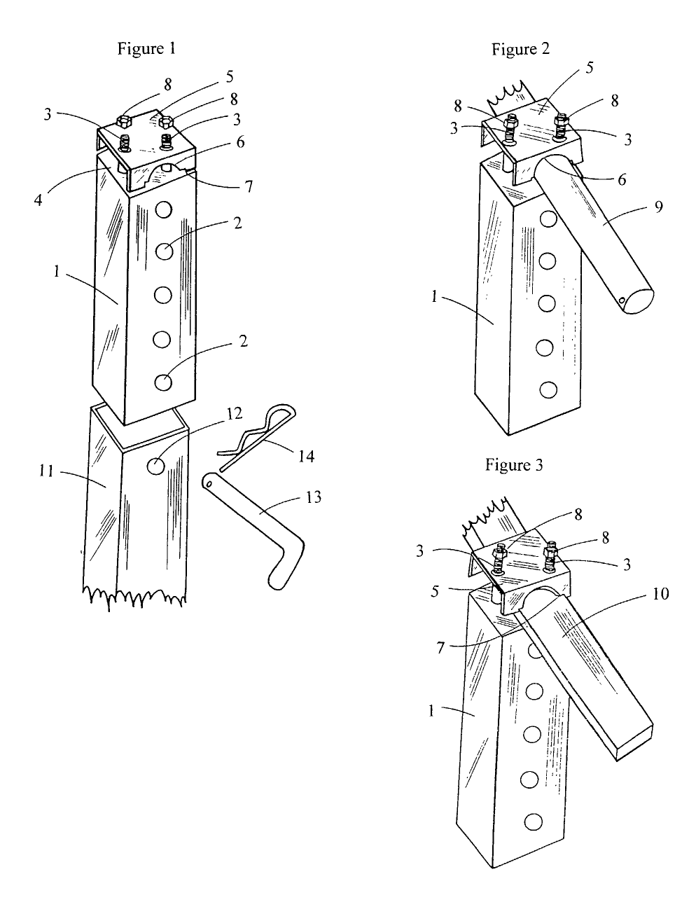

FIG. 1—Illustrates a view of the Universal Bar Carrier consisting of a tubular frame (1), with multiple adjustment holes (2), welded studs (3), and an end cap (4). The hold-down cap (5) fits onto the studs and is bolted in place with hold-down nuts (8). The hold-down cap has a cut out (6) on opposite sides to fit round tubing, and a cut out (7) on opposite sides to fit rectangular tubing. The tubular frame (1) is large enough to slide over a 2″×2″ square support (11) with a hole (12) to allow height adjustment by inserting pin (13) through the chosen holes (2) and (12). The keeper pin (14) prevents the adjustment pin from falling out.

FIG. 2—Illustrates the use of the tubular frame (1) with the round tube (9) held in place by the nuts (8) turned firmly onto the studs (3) forcing the hold-down cap (5) with circular cut outs (6) secure around the tube (9).

FIG. 3—Illustrates the use of the tubular frame (1) with the rectangular bar (10) held in place by nuts (8) turned firmly onto studs (3) forcing the hold-down cap (5) with rectangular cut outs (7) secure around the rectangular bar.

I claim:

What I claim is:

1. A device that slides over a vertical 2″×2″ square tube, having holes for height adjustment, and welded studs on top, onto which an end cap can be fastened while said end cap is notched to securely hold a 1⅛″ diameter tube or a ⅞″×¼″ rectangular tube, both of which are standard support tubes that will accept kayak saddles.
